(19) United States
(12) Patent Application Publication
(10) Pub. No.: US 2012/0276317 A1
(43) Pub. Date: Nov. 1, 2012

(54) OPTICALLY DIFFUSIVE ADHESIVE AND METHOD OF MAKING THE SAME

(76) Inventors: Kiu-Yuen Tse, Woodbury, MN (US); Peter B. Grasse, Woodbury, MN (US)

(21) Appl. No.: 13/511,499

(22) PCT Filed: Nov. 23, 2010
(86) PCT No.: PCT/US10/57728

§ 371 Date: May 23, 2012

Related U.S. Application Data
(60) Provisional application No. 61/267,556, filed on Dec. 8, 2009.

(51) Int. Cl. C09J 133/12; C09J 7/02; B32B 5/16

(52) U.S. Cl. 428/40.2; 523/303; 524/560; 428/327

(57) ABSTRACT

A method of making an optically diffusive adhesive comprises: preparing a first adhesive composition comprising first particles dispersed in an optically clear adhesive matrix; determining a first haze and a first clarity of the first adhesive composition; and based upon the first haze and the first clarity, preparing a second adhesive composition that comprises the optically clear adhesive matrix, the first particles, and second particles dispersed in the optically clear adhesive matrix. An optically diffusive adhesive comprises first and second particles dispersed in an optically clear adhesive matrix is also disclosed. The first and second particles have a higher refractive index than the optically clear adhesive matrix. Articles comprising the optically diffusive adhesive are also disclosed.

### TECHNICAL FIELD

The present disclosure broadly relates to adhesive compositions.

### BACKGROUND

Optically diffusive adhesives, and especially optically diffusive pressure-sensitive adhesives, that have varying levels of optical properties such as haze and clarity are widely used in the manufacturing arts. However, for any given optically diffusive adhesive composition, the ability to simultaneously control haze and clarity has been essentially a matter of haphazard trial and error. It would be desirable to have a predictable method by which haze and clarity of adhesive compositions can be independently controlled without excessive experimentation.

### SUMMARY

In one aspect, the present disclosure provides a method of making an optically diffusive adhesive, the method comprising:

a) preparing a first adhesive composition comprising a first weight percent of first particles dispersed in an optically clear adhesive matrix, wherein the first particles have a different refractive index than the optically clear adhesive matrix;

b) determining a first haze and a first clarity of the first adhesive composition; and

c) based upon the first haze and the first clarity, preparing a second adhesive composition that comprises the optically clear adhesive matrix, a second weight percent of the first particles, and a third weight percent of second particles dispersed in the optically clear adhesive matrix, wherein the second particles have a different refractive index than the optically clear adhesive matrix, wherein the second adhesive composition has a second haze and a second clarity, and wherein the second haze is within twenty percent of the first haze and the second clarity is different from the first clarity.

In some embodiments, the method further comprises:

d) based upon the second haze and the second clarity, preparing a third adhesive composition that comprises the optically clear adhesive matrix, a fourth weight percent of the first particles, and a fifth weight percent of second particles, wherein the third adhesive composition has a third haze and a third clarity, and wherein the third haze is within twenty percent of the first haze and the third clarity is different from the first clarity.

In some embodiments, the first particles have a smaller average diameter than the second particles and the second clarity is less than the first clarity. In some embodiments, the first particles have a larger average diameter than the second particles and the second clarity is greater than the first clarity.

In another aspect, the present disclosure provides an optically diffusive adhesive comprising:

an optically clear adhesive matrix;

first particles dispersed in the optically clear adhesive matrix, wherein the first particles comprise a first organic polymer; and

second particles dispersed in the optically clear adhesive matrix, wherein the second particles comprise a second organic polymer,

wherein the first particles and the second particles have different average particles sizes, and wherein the first particles and the second particles have a higher refractive index than the optically clear adhesive matrix.

The following embodiments pertain to each of the foregoing aspects of the present disclosure, unless otherwise indicated. In some embodiments, a sum of the second weight percent and the third weight percent is within ten percent of the first weight percent. In some embodiments, the first particles comprise a first organic polymer, and the second particles comprise a second organic polymer (which may be the same as, or different, than the first organic polymer). In some embodiments, the first particles and the second particles comprise polymethyl methacrylate. In some embodiments, the refractive index of the first particles is the same as the refractive index as the second particles. In some embodiments, the optically diffusive adhesive is a pressure-sensitive adhesive. In some embodiments, the first particles and the second particles have average particle sizes in a range of from 0.7 micrometer to 30 micrometers. In some embodiments, the first particles have a smaller average diameter than the second particles and the second clarity is less than the first clarity. In some embodiments, the first particles have a larger average diameter than the second particles and the second clarity is greater than the first clarity.

In another aspect, the present disclosure provides an article comprising:

an optically diffusive adhesive in contact with a first substrate, wherein the optically diffusive adhesive comprises:

an optically clear adhesive matrix;

first particles dispersed in the optically clear adhesive matrix, wherein the first particles comprise a first organic polymer; and

second particles dispersed in the optically clear adhesive matrix, wherein the first particles comprise a second organic polymer,

wherein the first particles and the second particles have different average particles sizes, and wherein the first particles and the second particles have a higher refractive index than the optically clear adhesive matrix.

In some embodiments, the article further comprises a second substrate, wherein the optically diffusive adhesive is sandwiched between the first substrate and the second substrate. In some embodiments, the optically diffusive adhesive is releasably adhered to the first substrate and optionally the second substrate. In some embodiments, the article comprises a tape (e.g., a roll of tape).

Advantageously, the method of the present disclosure provides a rapid route for effectively varying the clarity of an adhesive composition while maintaining its initial haze value, typically without substantially altering its adhesive properties.

As used herein, unless otherwise indicated:

the term “optically diffusive adhesive” or “optically diffusive pressure-sensitive adhesive” refers to an adhesive or pressure-sensitive adhesive that is optically transmissive and also diffuses visible light;

the term “dispersed” refers to particles distributed within a matrix in which the particles may be uniformly or randomly distributed.

the term “optically clear” refers to an adhesive or article that has a high light transmittance over at least a portion of the visible light spectrum (about 400 to about 700 nm), and that exhibits low haze; and

the term “optically transmissive” refers to an adhesive or article that has a high light transmittance over at least a portion of the visible light spectrum (about 400 to about 700 nm).

Haze, clarity, and optical transmittance may be determined using a HAZE-GARD PLUS meter available from BYK-Gardner Inc. of Silver Springs, Md., which complies with ASTM D1003-07e1 “Standard Test Method for Haze and Luminous Transmittance of Transparent Plastics”.

The features and advantages of the present disclosure will be understood upon consideration of the detailed description as well as the appended claims. These and other features and advantages of the disclosure may be described below in connection with various illustrative embodiments of the invention. The above summary is not intended to describe each disclosed embodiment or every implementation of the present invention. The Figures and the detailed description which follow more particularly exemplify illustrative embodiments.

### BRIEF DESCRIPTION OF THE DRAWING

FIG. 1 is a schematic side view of an exemplary article according to the present disclosure.

### DETAILED DESCRIPTION

The present disclosure stems from the inventors' discovery that optical properties such as haze and clarity of optically diffusive adhesives can be easily tailored for individual adhesive applications according to the method described above. More specifically, by keeping a substantially constant weight (e.g., with +/−ten percent) of total particles dispersed in the adhesive composition (i.e., first particles) and replacing a fraction of the first particles with larger or smaller second particles, the clarity can be adjusted largely independently of the haze. In general, replacement of the first particles with larger second particles results in lesser clarity, while replacement of the first particles with smaller second particles results in greater clarity.

The term “adhesive” as used herein refers to organic polymeric compositions useful for adhering together two adherends. Examples of adhesives include non-tacky adhesives (i.e., cold-seal adhesives), heat activated adhesives, structural adhesives and pressure-sensitive adhesives.

Non-tacky adhesives have limited or low tack to most substrates but can have acceptable adhesive strength when paired with specific target substrates or when two layers of the non-tacky adhesives are contacted. The non-tacky adhesive adheres by affinity.

Heat-activated adhesives are non-tacky at room temperature but become tacky and capable of bonding to a substrate at elevated temperatures. These adhesives usually have a T_{g} or melting point (Tₘ) above room temperature. When the temperature is elevated above the T_{g} or Tₘ, the storage modulus usually decreases and the adhesive become tacky.

Structural adhesives refer to adhesives that that can bond other high strength materials (e.g., wood, composites, or metal) so that the adhesive bond strength is in excess of 6.0 MPa (1000 psi).

Pressure-sensitive adhesive (PSA) compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend.

The optically clear adhesive matrix may have any composition. Examples of optically clear adhesive matrixes include acrylics, urethanes, epoxies, cyanates, and hot melt adhesives. The optically clear adhesive matrix can be a combination of multiple components (e.g., two or more of polymers and optionally tackifiers).

In some embodiments, the optically clear adhesive matrix is chosen such that it is a pressure-sensitive adhesive. Pressure-sensitive optically clear adhesive matrixes useful in the present disclosure include, for example, those based on natural rubbers, synthetic rubbers, styrene block copolymers, (meth)acrylic block copolymers, polyvinyl ethers, polyolefins, and poly(meth)acrylates, wherein the terms (meth)acrylate and (meth)acrylic include both acrylates and methacrylates.

One particularly suitable class of pressure-sensitive optically clear adhesive matrix is that of (meth)acrylate-based pressure-sensitive adhesives, which may comprise either an acidic or basic copolymer. In many embodiments, the (meth)acrylate-based pressure-sensitive adhesive is an acidic copolymer. Generally, as the proportion of acidic monomers used in preparing the acidic copolymer increases cohesive strength of the resulting adhesive increases. The proportion of acidic monomers is usually adjusted depending on the proportion of acidic copolymer present in the blends of the present disclosure.

To achieve pressure-sensitive adhesive characteristics, the corresponding copolymer can be tailored to have a resultant glass transition temperature (T_{g}) of less than about 0° C. Exemplary pressure-sensitive adhesive copolymers include (meth)acrylate copolymers. Such copolymers typically are derived from monomers comprising 40 percent by weight to 98 percent by weight, often at least 70 percent by weight, or at least 85 percent by weight, or even 90 percent by weight, of at least one alkyl(meth)acrylate monomer that, as a homopolymer, has a T_{g} of less than 0° C.

Examples of such alkyl(meth)acrylate monomers include those in which the alkyl groups comprise from 4 carbon atoms to 12 carbon atoms and include, but are not limited to, n-butyl acrylate, 2-ethylhexyl acrylate, isooctyl acrylate, isononyl acrylate, isodecyl acrylate, and mixtures thereof. Optionally, other vinyl monomers and alkyl(meth)acrylate monomers which, as homopolymers, have a T_{g} greater than 0° C. such as, for example, methyl acrylate, methyl methacrylate, isobornyl acrylate, vinyl acetate, and styrene, may be utilized in conjunction with one or more of the low T_{g} alkyl(meth)acrylate monomers and copolymerizable basic or acidic monomers, provided that the T_{g} of the resultant (meth)acrylate copolymer is less than about 0° C.

In some embodiments, it is desirable to use (meth)acrylate monomers that are free of alkoxy groups. Alkoxy groups are understood by those skilled in the art.

When used, basic (meth)acrylate copolymers useful as pressure-sensitive optically clear adhesive matrixes typically are derived from basic monomers comprising 2 percent by weight to 50 percent by weight, or 5 percent by weight to 30 percent by weight, of a copolymerizable basic monomer.

When used to form the pressure-sensitive adhesive matrix, acidic (meth)acrylate copolymers typically are derived from acidic monomers comprising 2 percent by weight to 30 percent by weight, or 2 percent by weight to 15 percent by weight, of a copolymerizable acidic monomer.

In certain embodiments, the poly(meth)acrylic pressure-sensitive adhesive matrix is derived from between 1 and 20 weight percent of acrylic acid and between 99 and 80 weight percent of at least one of isooctyl acrylate, 2-ethyl-hexyl acrylate or n-butyl acrylate composition. In some embodiments, the pressure-sensitive adhesive matrix is derived from between 2 and 10 weight percent acrylic acid and between 90 and 98 weight percent of at least one of isooctyl acrylate, 2-ethyl-hexyl acrylate or n-butyl acrylate composition.

Another useful class of optically clear (meth)acrylate-based pressure-sensitive adhesives are those which are (meth)acrylic block copolymers. Such copolymers may contain only (meth)acrylate monomers or may contain other co-monomers such as styrenes. Examples of such pressure-sensitive adhesives are described, for example in U.S. Pat. No. 7,255,920 (Everaerts et al.).

Optically clear pressure-sensitive adhesives may be inherently tacky. If desired, tackifiers may be added to a base material to form a pressure-sensitive adhesive. Useful tackifiers include, for example, rosin ester resins, aromatic hydrocarbon resins, aliphatic hydrocarbon resins, and terpene resins. Other materials can be added for special purposes, including, for example, oils, plasticizers, antioxidants, ultraviolet (UV) stabilizers, hydrogenated butyl rubber, pigments, curing agents, polymer additives, thickening agents, chain transfer agents and other additives provided that they do not reduce the optical clarity of the pressure-sensitive adhesive.

In some embodiments, it is desirable for the optically clear adhesive matrix to be used in conjunction with a crosslinking agent. The choice of crosslinking agent depends upon the nature of polymer or copolymer which one wishes to crosslink The crosslinking agent is typically used in an effective amount, by which is meant an amount that is sufficient to cause crosslinking of the pressure-sensitive adhesive to provide adequate cohesive strength to produce the desired final adhesion properties to the substrate of interest. Generally, when used, the crosslinking agent is used in an amount of 0.1 part to 10 parts by weight, based on the total amount of monomers.

One class of useful crosslinking agents includes multifunctional (meth)acrylate species. Multifunctional (meth)acrylates include tri(meth)acrylates and di(meth)acrylates (that is, compounds comprising three or two (meth)acrylate groups). Typically, di(meth)acrylate crosslinkers (that is, compounds comprising two (meth)acrylate groups) are used. Useful tri(meth)acrylates include, for example, trimethylolpropane tri(meth)acrylate, propoxylated trimethylolpropane triacrylates, ethoxylated trimethylolpropane triacrylates, tris(2-hydroxyethyl)isocyanurate triacrylate, and pentaerythritol triacrylate. Useful di(meth)acrylates include, for example, ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, alkoxylated 1,6-hexanediol diacrylates, tripropylene glycol diacrylate, dipropylene glycol diacrylate, cyclohexanedimethanol di(meth)acrylate, alkoxylated cyclohexanedimethanol diacrylates, ethoxylated bisphenol A di(meth)acrylates, neopentyl glycol diacrylate, polyethylene glycol di(meth)acrylates, polypropylene glycol di(meth)acrylates, and urethane di(meth)acrylates.

Another useful class of crosslinking agents has functionality that is reactive with carboxylic acid groups on the acrylic copolymer. Examples of such crosslinking agents include multifunctional aziridine, isocyanate, and epoxy compounds. Examples of aziridine-type crosslinkers include, for example,
1,4-bis(ethyleneiminocarbonylamino)benzene,
4,4′-bis(ethyleneiminocarbonylamino)diphenylmethane,
1,8-bis(ethyleneiminocarbonylamino)octane, and
1,1′-(1,3-phenylenedicarbonyl)-bis-(2-methylaziridine).
   Common polyfunctional isocyanate crosslinkers include, for example, trimethylolpropane toluene diisocyanate, tolylene diisocyanate, and hexamethylene diisocyanate.

The optically clear adhesive matrix has a refractive index which may be higher or lower than the refractive index of the first and/or second particles, which are blended with it. Typically, the optically clear adhesive matrix has a refractive index in the range of 1.45-1.56, although this is not a requirement. Many pressure-sensitive adhesives have refractive indices of 1.47 or less, but recently pressure-sensitive adhesives with higher refractive indices, such as at least 1.48 or even at least 1.50 or greater have been prepared, for example as described in U.S. Pat. No. 7,166,686 (Olson et al.).

Any particles are suitable for use as the first and second particles as long as the particles can withstand the preparation and coating conditions and have a refractive index which is different (e.g., higher or lower) than the refractive index for the adhesive matrix. The particles may be in a variety of shapes, but typically the particles are spherical or generally spherically shaped.

Among the classes of particles that are suitable are inorganic particles and organic particles.

Examples of inorganic particles include silica particles, glass beads, zirconia particles, and antimony pentoxide particles.

Examples of organic particles include silicone resin particles, which are sometimes called polymethylsilsesquioxane particles and acrylic particles. Some of these particles are crosslinked. It may be desirable for the particles to be crosslinked to avoid dissolving in solvent or mixtures of monomers which may be present with the adhesive matrix.

Exemplary silicone resin particles include those available from Momentive Performance Materials of Albany, N.Y., under the trade designation “TOSPEARL” such as, for example, TOSPEARL 120, TOSPEARL 120A, TOSPEARL 130, TOSPEARL 130A, TOSPEARL 145, TOSPEARL 145A, TOSPEARL 240, TOSPEARL 3120, TOSPEARL 2000B, TOSPEARL 3000A, TOSPEARL 1110A.

Exemplary acrylic particles include polymethyl methacrylate (PMMA) beads available from Soken Chemical America of Fayetteville, Ga., under the trade designations MX2000, MX80H3WT, and MX180.

The first and second particles may be formed of the same or different materials and may have the same or different refractive indexes. Typically, the first and second particles are chosen such that they have substantially the same refractive index.

Typically, the first and second particles have an average particle size in a range of from 0.7 micrometer to 30 micrometers, or more, although other sizes may also be used. In some embodiments, the first and second particles have average particle sizes in a range is from 1 micrometer to 20 micrometers, or even 2 to 15 micrometers.

The particles may be used in any amount, but typically at least 0.5 weight percent and no more than 60 weight percent are added. In some embodiments, at least 1 weight percent is added, in other embodiments 2 weight percent, 5 weight percent, 10 weight percent, 15 weight percent, 25 weight percent, 40 weight percent or even 60 weight percent may be used.

The particles used in a given formulation may be selected to have a refractive index which is greater than or less than the chosen optically clear adhesive matrix. Additional other criteria, such as particle size, particle loading level and so forth may also be used to control the final performance features of the diffusive adhesive.

In some embodiments, the optically diffusive adhesives of the present disclosure are pressure-sensitive adhesives that also function to diffuse visible light without a significant amount of backscattered light. In some embodiments the haze value is at least 10 percent, 20 percent, 30 percent, 40 percent, 50 percent, or greater. Advantageously, by keeping the total weight of first and second particles substantially constant, the adhesive properties are typically minimally affected, if at all.

In some embodiments (e.g., in the case of acrylic pressure-sensitive adhesives), an optically clear adhesive matrix may be prepared by any conventional polymerization technique useful to prepare such adhesives. When the optically clear adhesive matrix is a (meth)acrylate copolymer, the copolymers can be prepared by any conventional free-radical polymerization method, including solution, radiation, bulk, dispersion, emulsion, and suspension processes. In one solution polymerization method, the monomers, along with a suitable inert organic solvent, are charged into a four-neck reaction vessel that is equipped with a stirrer, a thermometer, a condenser, an addition funnel, and a temperature controller.

A concentrated thermal free-radical initiator solution is added to the addition funnel The whole reaction vessel, addition funnel, and their contents are then purged with nitrogen to create an inert atmosphere. Once purged, the solution within the vessel is heated to an appropriate temperature to activate the free-radical initiator to be added, the initiator is added, and the mixture is stirred during the course of the reaction. A 98 percent to 99 percent conversion can typically be obtained in 20 hours.

Bulk polymerization methods, such as the continuous free-radical polymerization method described in U.S. Pat. Nos. 4,619,979 and 4,843,134 (both to Kotnour et al.); the essentially adiabatic polymerization methods using a batch reactor described in U.S. Pat. No. 5,637,646 (Ellis); suspension polymerization processes described in U.S. Pat. No. 4,833,179 (Young et al.); and, the methods described for polymerizing packaged pre-adhesive compositions described in U.S. Pat. No. 5,932,298 (Hamer et al.) may also be utilized to prepare the polymers.

Suitable thermal free-radical initiators which may be utilized include, but are not limited to, those selected from azo compounds, such as 2,2′-azobis(isobutyronitrile); hydroperoxides, such as tert-butyl hydroperoxide; and, peroxides, such as benzoyl peroxide and cyclohexanone peroxide. Photoinitiators which are useful include, but are not limited to, those selected from benzoin ethers, such as benzoin methyl ether or benzoin isopropyl ether; substituted benzoin ethers, such as anisole methyl ether; substituted acetophenones, such as 2,2-diethoxyacetophenone and 2,2-dimethoxy-2-phenyl acetophenone; substituted alpha-ketols, such as 2-methyl-2-hydroxypropiophenone; aromatic sulfonyl chlorides, such as 2-naphthalene sulfonyl chloride; and, photoactive oximes, such as 1-phenyl-1,2-propanedione-2-(ethoxycarbonyl)oxime. For both thermal- and radiation-induced polymerizations, the initiator is present in an amount of 0.05 percent to 5.0 percent by weight based upon the total weight of the monomers.

Both solventless and solvent borne techniques may be used to coat the optically diffusive adhesive. For solventless embodiments, the optically diffusive adhesive is typically prepared by a coat and cure technique. In this technique a coatable mixture is coated on a web and then subjected to curing, generally photochemically. The web may be a backing, substrate, release liner or the like. If the coatable mixture contains only monomers, the viscosity may not be sufficiently high to be readily coatable. Several techniques may be used to generate a mixture with a coatable viscosity. A viscosity modifying agent may be added such as high or relatively high molecular weight species or thixotropic agents such as colloidal silicas, etc. Alternatively, a monomer mixture can be partially prepolymerized to give a coatable syrup as described in, for example, U.S. Pat. No. 6,339,111 (Moon et al.).

The first and second particles may be dispersed within the optically clear adhesive matrix at any stage of this process prior to coating and curing. For example, they may be dispersed in the monomer mixture, in the monomer mixture with added modifying agent or to the coatable syrup. For ease of dispersal, the particles are typically added to the monomer mixture or the coatable syrup.

An initiator or initiators may be used to prepare a coatable syrup as well as to initiate polymerization of the optically clear adhesive matrix polymer after coating. These initiators may be the same or different, and each initiator may be a thermal initiator or a photoinitiator. Typically, for ease of processing, photoinitiators are used. Examples of useful photoinitiators include benzoin ethers such as benzoin methyl ether and benzoin isopropyl ether; substituted phosphine oxides such as 2,4,6-trimethylbenzoyldiphenylphosphine oxide available as LUCIRIN TPO-L from BASF Corp. of Florham Park, N.J.; substituted acetophenones such as 2,2-diethoxyacetophenone, available as IRGACURE 651 photoinitiator from Ciba Specialty Chemicals of Tarrytown, N.Y., 2,2-dimethoxy-2-phenyl-1-phenylethanone, available as ESACURE KB-1 photoinitiator from Sartomer Co. of Exton, Pa., and dimethoxyhydroxyacetophenone; substituted α-ketols such as 2-methyl-2-hydroxypropiophenone; such as 2-naphthalenesulfonyl chloride; such as 1-phenyl-1,2-propanedione-2-(O-ethoxycarbonyl)oxime. Particularly useful are the substituted acetophenones or 2,4,6-trimethylbenzoyldiphenylphosphine oxide.

While solventless embodiments are visualized within the scope of this disclosure, in embodiments where the optically clear adhesive matrix is prepared and blended with particles as opposed to the cast and cure techniques just described, it is typical that solvents are used in blending and coating the diffusive adhesive compositions. In particular, solventless coating methods such as hot melt coating have been observed to cause orientation in the adhesive coating and this orientation can cause optical birefringence. Optical birefringence is the resolution or splitting of a light wave into two unequally reflected or transmitted waves by an optically anisotropic medium. Suitable solvents include ethyl acetate, acetone, methyl ethyl ketone, heptane, toluene, and alcohols such as methanol, ethanol and isopropanol and mixtures thereof. If used, the amount of solvent is generally 30-80 percent by weight based on the total weight of the components (polymers, crosslinkers and any additives) and solvent. The particles may be mixed with the solvent mixture using any convenient mixing or blending technique such as, for example, hand stirring, mechanical stirring, mechanical mixing, and/or mechanical shaking.

The solvent-borne optically diffusive adhesives can be coated by any suitable process, such as by, for example, knife coating, roll coating, gravure coating, rod coating, curtain coating, and air knife coating. They may also be printed by known methods such as screen printing or inkjet printing. Once coated from solvent, the optically diffusive adhesive is typically obtained by removal of the solvent. In some embodiments, the coating is subjected to increased temperatures such as supplied by an oven (e.g. a forced air oven) in order to expedite the drying of the adhesive.

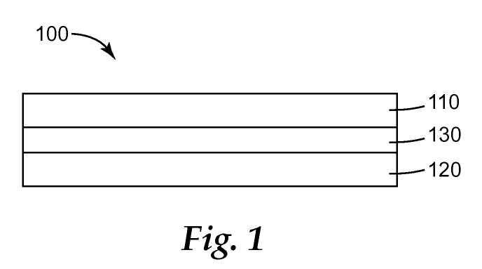

Optically diffusive adhesives according to the present disclosure may be used to make optical articles. Referring now to FIG. 1, an exemplary article 100 according to the present disclosure comprises first substrate 120, and optional second substrate 110. Optically diffusive adhesive 130 contacts first substrate 120, and (if optional second substrate 110 is present) is sandwiched between first substrate 120 and optional second substrate 110.

In some embodiments, the first substrate and optional second substrate comprise release liners, and the optically diffusive adhesive is releasably adhered thereto. Such embodiments include, for example, tapes and adhesive sheets.

In some embodiments, the first substrate comprises an optical film. The optically diffusive adhesive may be particularly useful in applications in which a separate diffuser layer or film is currently used. Diffusive layers are used, for example, in applications where there is a point light source such as a light bulb or an LED, or a series of such point light sources, and it is desirable to diffuse the light from the point source to produce a desirable background brightness. Such uses include information displays, such as liquid crystal displays, light boxes for graphic displays, and rear projection screens.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

TABLE OF ABBREVIATIONS

| ABBREVIATION | DESCRIPTION |
|---|---|
| EHA | 2-ethylhexyl acrylate, from BASF Specialty Amines |
| | of Mount Olive, NJ |
| HEA | 2-hydroxyethyl acrylate, from BASF |
| IOA | isooctyl acrylate, from 3M Co. of St Paul, MN |
| AA | acrylic acid, from BASF |
| HDDA | 1,6-hexanediol diacrylate, available as PHOTOMER |
| | 4017 from Cognis Corp. USA of Cincinnati, OH |
| IRG651 | 2,2-dimethoxy-2-phenylacetophenone, a |
| | photoinitiator available as IRGACURE 651 from |
| | Ciba Specialty Chemicals of Tarrytown, NY |
| MX2000 | PMMA beads (20 micron average diameter) |
| | available as MX2000 from Soken Chemical |
| | America of Fayetteville, GA |
| MX80H3WT | PMMA beads (0.8 micron average diameter) |
| | available as MX80H3WT from Soken Chemical |
| | America |
| MX180 | PMMA beads (1.8 micron average diameter) |
| | available as MX180 from Soken Chemical |
| | America |

### Luminous Transmittance and Haze and Clarity Test

Adhesive specimens for testing were prepared by transferring the adhesive from a release liner to a glass microscope slide.

Luminous transmittance, haze, and clarity were measured using a HAZEGARD PLUS haze meter from BYK-Gardner Inc. of Silver Springs, Md.

### Preparatory Example 1

A monomer premix was prepared by mixing IOA (96 parts), AA (4 parts), and IRG651 (0.04 parts). This mixture was purged with nitrogen for at least 10 minutes. The mixture was then partially polymerized under a nitrogen-rich atmosphere by exposure to ultraviolet radiation to provide a coatable syrup having a viscosity of about 500-3000 cP (0.5-3 Pa-sec). To 200 grams (g) of this syrup was added 6.54 g of AA, 36.36 g of HEA, 4.4 g of a 10 percent solution of Irg651 in EHA, and 1.6 g of a 10 percent solution of HDDA in EHA, followed by thorough mixing before use.

### Preparatory Example 2

A monomer premix was prepared using EHA (96 parts), HEA (4 parts), and photoinitiator IRG651 (0.04 parts). This mixture was purged with nitrogen for at least 10 minutes. The mixture was then partially polymerized under a nitrogen-rich atmosphere by exposure to ultraviolet radiation to provide a coatable syrup having a viscosity of about 500-3000 cP (0.5-3 Pa-sec). To 200 g of this syrup was added 6.55 g of AA, 36.36 g of HEA, 0.44 g of IRG651, and 1.6 g of a 10 percent solution of HDDA in EHA, followed by thorough mixing before use.

### Comparative Example C1

A solventless bead dispersion was made by dispersing 4.4 g of MX80H3WT in 7.86 g of IOA. To this dispersion was added 12.4 g of the syrup from PREPARATORY EXAMPLE 1. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Comparative Example C2

A solventless bead dispersion was made by dispersing 4.4 g of MX180 in 7.86 g of IOA. To this dispersion was added 12.4 g of the syrup from PREPARATORY EXAMPLE 1. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Comparative Example C3

A solventless bead dispersion was made by dispersing 9.4 g of MX1500 in 7.86 g of IOA. To this dispersion was added 12.4 g of the syrup from PREPARATORY EXAMPLE 1. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Comparative Example C4

A solventless bead dispersion was made by dispersing 9.4 g of MX2000 in 7.86 g of IOA. To this dispersion was added 12.4 g of the syrup from PREPARATORY EXAMPLE 1. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Comparative Example C5

A solventless bead dispersion was made by dispersing 3.74 g of MX180 in 4.3 g of EHA. To this dispersion was added 6.8 g of the syrup from PREPARATORY EXAMPLE 2. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Comparative Example C6

A solventless bead dispersion was made by dispersing 3.74 g of MX2000 in 4.3 g of EHA. To this dispersion was added 6.8 g of the syrup from PREPARATORY EXAMPLE 2. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Example 1

A solventless bead dispersion was made by dispersing a mixture of 3.4 g of MX80H3WT and 3.4 g of MX2000 in 7.86 g of IOA. To this dispersion was added 12.4 g of the syrup from PREPARATORY EXAMPLE 1. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

Based on the haze and clarity values obtained for this sample, COMPARATIVE EXAMPLES C1 and C4, relative to the desired target values, the next version of the coatable composition was prepared as described in EXAMPLE 2 (below).

### Example 2

A solventless bead dispersion was made by dispersing a mixture of 3.4 g of MX80H3WT and 3.4 g of MX1500 in 7.86 g of IOA. To this dispersion was added 12.4 g of the syrup from PREPARATORY EXAMPLE 1. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Example 3

To reduce clarity compared to COMPARATIVE EXAMPLE C5, a solventless bead dispersion was made by dispersing a mixture of 2.49 g of MX180 and 1.25 of MX2000 in 4.3 g of EHA. To this dispersion was added 6.8 g of the syrup from PREPARATORY EXAMPLE 2. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

### Example 4

To reduce clarity compared to COMPARATIVE EXAMPLE C5, a solventless bead dispersion was made by dispersing a mixture of 1.25 g of MX180 and 2.49 of MX2000 in 4.3 g of EHA. To this dispersion was added 6.8 g of the syrup from PREPARATORY EXAMPLE 2. This composition was then knife coated on a silicone-treated PET release liner at a thickness of 1.5±0.5 mils (38±13 micrometers). Another silicone-treated PET release liner was placed on top of the resulting coating which was then exposed to ultraviolet radiation having a spectral output from 300-400 nm with a maximum at 351 nm (a total energy of about 1 J/cm²). Transmission, haze and clarity tests were performed on this sample and the results are reported in Table 1.

TABLE 1

| EXAMPLE | TRANSMITTANCE, % | HAZE, % | CLARITY, % |
|---|---|---|---|
| COMPARATIVE | 93.6 | 28.4 | 91.3 |
| EXAMPLE C1 | | | |
| COMPARATIVE | 93.5 | 26.0 | 86.9 |
| EXAMPLE C2 | | | |
| COMPARATIVE | 91.6 | 25.9 | 37.3 |
| EXAMPLE C3 | | | |
| COMPARATIVE | 91.9 | 21.9 | 40.8 |
| EXAMPLE C4 | | | |
| COMPARATIVE | 93.6 | 56.1 | 87.9 |
| EXAMPLE C5 | | | |
| COMPARATIVE | 94.2 | 31.9 | 34.4 |
| EXAMPLE C6 | | | |
| EXAMPLE 1 | 92.8 | 27.4 | 65.8 |
| EXAMPLE 2 | 92.6 | 30.4 | 66.2 |
| EXAMPLE 3 | 93.7 | 46.8 | 60.8 |
| EXAMPLE 4 | 94 | 38.3 | 44.2 |

All patents and publications referred to herein are hereby incorporated by reference in their entirety. All examples given herein are to be considered non-limiting unless otherwise indicated. Various modifications and alterations of this disclosure may be made by those skilled in the art without departing from the scope and spirit of this disclosure, and it should be understood that this disclosure is not to be unduly limited to the illustrative embodiments set forth herein.

1. A method of making an optically diffusive adhesive, the method comprising:
a) preparing a first adhesive composition comprising a first weight percent of first particles dispersed in an optically clear adhesive matrix, wherein the first particles have a different refractive index than the optically clear adhesive matrix;
b) determining a first haze and a first clarity of the first adhesive composition; and
c) based upon the first haze and the first clarity, preparing a second adhesive composition that comprises the optically clear adhesive matrix, a second weight percent of the first particles, and a third weight percent of second particles dispersed in the optically clear adhesive matrix, wherein the second particles have a different refractive index than the optically clear adhesive matrix, wherein the second adhesive composition has a second haze and a second clarity, and wherein the second haze is within twenty percent of the first haze and the second clarity is different from the first clarity.

2. The method of claim 1, wherein a sum of the second weight percent and the third weight percent is within ten percent of the first weight percent.

3. The method of claim 1, wherein the first particles comprise a first organic polymer, and wherein the second particles comprise a second organic polymer.

4. The method of claim 1, wherein the first organic polymer and the second organic polymer are the same.

5. The method of claim 1, wherein the first particles and the second particles have average particle sizes in a range of from 0.7 micrometer to 30 micrometers.

6. The method of claim 1, wherein the first particles have a smaller average diameter than the second particles, and wherein the second clarity is less than the first clarity.

7. The method of claim 1, wherein the first particles have a larger average diameter than the second particles, and wherein the second clarity is greater than the first clarity.

8. The method of claim 1, wherein the refractive index of the first particles is the same as the refractive index as the second particles.

9. The method of claim 1, wherein the optically diffusive adhesive is a pressure-sensitive adhesive.

10. The method of claim 1, further comprising:
d) based upon the second haze and the second clarity, preparing a third adhesive composition that comprises the optically clear adhesive matrix, a fourth weight percent of the first particles, and a fifth weight percent of second particles, and wherein the third adhesive composition has a third haze and a third clarity, and wherein the third haze is within twenty percent of the first haze and the third clarity is different from the first clarity.

11. The method of claim 10, wherein the first particles have a smaller average diameter than the second particles, and wherein the third clarity is less than the second clarity.

12. The method of claim 10, wherein the first particles have a larger average diameter than the second particles, and wherein the third clarity is greater than the second clarity.

13. An optically diffusive adhesive comprising:
an optically clear adhesive matrix;
first particles dispersed in the optically clear adhesive matrix, wherein the first particles comprise a first organic polymer; and
second particles dispersed in the optically clear adhesive matrix, wherein the first particles comprise a second organic polymer,
wherein the first particles and the second particles have different average particle sizes, and wherein the first particles and the second particles have a higher refractive index than the optically clear adhesive matrix.

14. The optically diffusive adhesive of claim 13, wherein the first particles and the second particles comprise polymethyl methacrylate.

15. The optically diffusive adhesive of claim 13, wherein the optically diffusive adhesive is a pressure-sensitive adhesive.

16. The optically diffusive adhesive of claim 13, wherein the first particles and the second particles have average particle sizes in a range of from 0.7 micrometer to 30 micrometers.

17. An article comprising:
an optically diffusive adhesive in contact with a first substrate, wherein the optically diffusive adhesive comprises:
an optically clear adhesive matrix;
first particles dispersed in the optically clear adhesive matrix, wherein the first particles comprise a first organic polymer; and
second particles dispersed in the optically clear adhesive matrix, wherein the second particles comprise a second organic polymer,
wherein the first particles and the second particles have different average particle sizes, and wherein the first particles and the second particles have a higher refractive index than the optically clear adhesive matrix.

18. The article of claim 17, wherein the optically diffusive adhesive is releasably adhered to the first substrate.

19. The article of claim 17, wherein the article comprises a tape.

20. The article of claim 17, further comprising a second substrate, wherein the optically diffusive adhesive is sandwiched between the first substrate and the second substrate.

21. The article of claim 20, wherein the optically diffusive adhesive is releasably adhered to the first substrate and the second substrate.

22. The article of claim 20, wherein the article comprises a tape.
